(19) United States
(12) Patent Application Publication
(10) Pub. No.: US 2024/0246493 A1
(43) Pub. Date: Jul. 25, 2024

(54) REAR MOUNTED BIKE RACK FOR AUTOMOBILES

(71) Applicant: Hill Ready, LLC, Colorado Springs, CO (US)

(72) Inventors: Daniel L. Gaide, Colorado Springs, CO (US); Matthew A. Gaide, Fort Wright, KY (US)

(21) Appl. No.: 18/625,632

(22) Filed: Apr. 3, 2024

Related U.S. Application Data
(63) Continuation of application No. 18/134,923, filed on Apr. 14, 2023.
(60) Provisional application No. 63/331,159, filed on Apr. 14, 2022.

(51) Int. Cl. B60R 9/10; B60R 9/06

(52) U.S. Cl. CPC B60R 9/10; B60R 9/06

(57) ABSTRACT

A rear mounted vehicle bike rack includes several adjustable features that allow the bike rack to be configured for a desired use, and to enable normal access to the vehicle rear cargo area. The bike rack includes two sets of telescoping arms that may be independently diagonally retracted or extended to adjust the distance at which the rack or a carried bike is positioned from the vehicle hatch door, and the height above the road surface at which the rack or carried bike is positioned. A cargo assembly of the bike rack stays parallel to the road surface during adjustment of the telescoping arms and includes a folding shelf portion that may be positioned to increase the cargo surface area. A hitch assembly allows a proximal set of telescoping arms to rotate upwards towards the vehicle into a storage position when the bike rack is not in use.

### CROSS REFERENCE TO RELATED APPLICATION

This application is a continuation application of U.S. patent Application No. 18/134,923, filed Apr. 14, 2023, which claims the benefit of U.S. Provisional Application No. 63/331,159, filed Apr. 14, 2022, wherein the disclosure of each is hereby incorporated by reference in their entirety.

### TECHNICAL FIELD

The disclosed technology pertains to a rear mounted bike rack for automobiles.

### BACKGROUND

Conventional rear mounted bike racks typically mount to a vehicle's hitch receiver and may include a vertical post just beyond the vehicle's rear bumper to raise the point at which the bike's frame rests on the rack above the road surface or may include a wheel receiver positioned closer to the road surface on which the bike's wheels may rest. In each case, conventional bike racks typically position the bike receiving surface e.g., whether receiving the bike frame or wheels as close to the hitch receiver as possible in order to reduce the torque and other mechanical forces applied to the rack and the vehicle during use. While such an approach has some advantages, the result is that conventional rear mounted bike racks typically block and prevent use of the vehicle's trunk for access to the vehicle's rear cargo area e.g., racks that receive the bike's frame typically include a vertical post that blocks the trunk door even when bikes are not loaded, and wheel receiving racks will block the trunk door when bikes are loaded. This is especially true for sport utility vehicles, passenger vans, and other vehicles having vertically arranged trunk doors that rotate vertically upwards or horizontally outwards when opening.

Further disadvantages of conventional bike racks include low ground clearance e.g., wheel-receiving racks can scrape the road surface on hills or bumps, poor rear-clearance e.g., statically positioned racks can extend several feet outwards from the rear of the vehicle even when not loaded, a lack of versatility e.g., conventional racks obstruct the rear of the vehicle even when unloaded, and provide few other benefits, and poor ease of use e.g., difficult installation and removal and lack of storage options often results in the user just leaving the rack installed even when unloaded, and even when the rack significantly obstructs trunk use, ground clearance, rear clearance, etc. What is needed, therefore, is an improved rear mounted bike rack.

### BRIEF DESCRIPTION OF THE DRAWINGS

Various embodiments will become better understood with regard to the following description, appended claims, and accompanying drawings wherein:

FIG. 1A is a front perspective view of an exemplary bike rack with only a first telescopic stage mounted on a vehicle;

FIG. 1B is a front perspective view of an exemplary bike rack with both a first and second telescopic stage;

FIG. 1C is a front perspective view of the bike rack of FIG. 1B loaded with cargo and bikes;

FIG. 2A is a side elevation view of the bike rack of FIG. 1 in a fully extended position;

FIG. 2B is a side elevation view of the bike rack in a storage position;

FIG. 3A is a front perspective view of one embodiment of the bike rack of FIG. 1B;

FIG. 3B is a front perspective view of a second embodiment of the bike rack of FIG. 1B

FIG. 4A is a bottom view of the bike rack of FIG. 1 in a fully extended position;

FIG. 4B is a is a rear profile view of the bike rack after configuring an exemplary cargo assembly at a first step of placing the bike rack in the storage position of FIG. 2B;

FIG. 4C is a is a front profile view of the bike rack after configuring an exemplary first pair of telescoping arms at a second step of placing the bike rack in the storage position of FIG. 2B;

FIG. 4D is a is a rear profile view of the bike rack after configuring an exemplary second pair of telescoping arms at a third step of placing the bike rack in the storage position of FIG. 2B;

FIG. 4E is a bottom view of the bike rack while configured as illustrated in FIG. 4D;

FIG. 4F is a is a rear profile view of the bike rack after configuring an exemplary hitch assembly at a fourth step of placing the bike rack in the storage position of FIG. 2B;

FIG. 5A is a bottom profile view of an exemplary cargo assembly in a partially disassembled state;

FIG. 5B is a side elevation cross sectional view of the cargo assembly;

FIG. 5C is a side elevation cross sectional view of the cargo assembly with a set of dashed lines illustrating an exemplary mounting point for a telescoping arm;

FIG. 6A is a front perspective view of an exemplary telescoping arm of the first pair of telescoping arms of FIG. 3A;

FIG. 6B is a cross sectional view of the telescoping arm of FIG. 6A;

FIG. 6C is a front perspective view of an exemplary locking mechanism isolated from the telescoping arm of FIG. 6A:

FIG. 6D is a plan view of an exemplary cam mechanism of the locking mechanism of FIG. 6C;

FIG. 6E is a cross sectional view of the cam mechanism of FIG. 6D within the telescoping arm, illustrating the engagement of the cam mechanism with an exemplary housing of the telescoping arm;

FIG. 6F is a front perspective view of an exemplary telescoping arm of the first pair of telescoping arms of FIG. 3B;

FIG. 6G is a cross sectional view of the telescoping arm of FIG. 6F;

FIG. 6H is a front perspective view of an exemplary locking mechanism isolated from the telescoping arm of FIG. 6F;

FIG. 6I is a front perspective view of the locking mechanism of FIG. 6H mounted on the smallest tube of a telescoping arm;

FIG. 6J is a cross sectional view of the sled mechanism of FIG. 6I;

FIG. 7A is a front perspective view of an exemplary telescoping arm of the second pair of telescoping arms of FIG. 3A;

FIG. 7B is a rear perspective view of an exemplary locking mechanism of FIG. 7A isolated from the telescoping arm;

FIG. 7C is a front perspective view of an exemplary telescoping arm of the second pair of telescoping arms of FIG. 3B;

FIG. 7D is a rear perspective view of an exemplary locking mechanism of FIG. 7C isolated from the telescoping arm;

FIG. 8A is a front perspective view of an exemplary hitch assembly;

FIG. 8B is a rear perspective view of the hitch assembly of FIG. 8A;

FIG. 8C is an exploded view showing several components of the hitch assembly of FIG. 8A;

FIG. 8D is a rear profile view of an exemplary pivot mount for the telescoping arm of FIG. 8A;

FIG. 8E is a side elevation cross sectional view of the hitch assembly of FIG. 8A illustrating a first rotational position of the pivot mount;

FIG. 8F is a side elevation cross sectional view of the hitch assembly of FIG. 8A illustrating a second rotational position of the pivot mount;

FIG. 9A is a front perspective view of an exemplary hitch assembly;

FIG. 9B is an exploded view showing several components of the hitch assembly of FIG. 9A;

FIG. 10A is a front perspective view of a vertical orientation bike receiver;

FIG. 10B is a front perspective view of an exemplary bike rack with multiple bikes stored in a vertical orientation;

FIG. 10C is a front perspective view of an exemplary bike rack with the cradle arms of the plurality of vertical orientation bike receivers pivoted down in a stowed away position;

FIG. 10D is a front perspective view of an exemplary bike rack with the cradle arms of the plurality of vertical orientation bike receivers pivoted up in an extended storage position;

FIG. 11 is a front perspective view of a bike rack including a single telescopic arm mounted to the rear of a vehicle;

FIG. 12 is a side perspective view of a bike rack having a single first telescopic arm and a single second telescopic arm;

FIG. 13A is a bottom perspective view of a bike rack in an extended state having a pair of telescopic arms which cross one another to form an X brace; and

FIG. 13B is a bottom perspective view of the bike rack of FIG. 13A in a storage state.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings, wherein like numbers indicate the same or corresponding elements throughout the views. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, it should be understood that unless otherwise specified or required by context, any explicit or implicit ordering of steps performed in the execution of a method does not imply that those steps must be performed in the order presented but instead may be performed in a different order or in parallel.

The inventors have conceived of novel technology that, for the purpose of illustration, is disclosed herein as applied in the context of rear mounted bike racks. While the disclosed applications of the inventors' technology satisfy a long-felt but unmet need in the art of rear mounted bike racks, it should be understood that the inventors' technology is not limited to being implemented in the precise manners set forth herein but could be implemented in other manners without undue experimentation by those of ordinary skill in the art in light of this disclosure. Accordingly, the examples set forth herein should be understood as being illustrative only and should not be treated as limiting.

The disclosed technology may be implemented to provide a rear mounted bike rack that is configurable into a variety of states depending upon a user's needs. Such implementations may include a bike rack that is configurable into a fully extended horizontal position, where the bike rack can hold one or more bikes and other cargo; an extended vertical position, where the bike rack can hold one or more bikes in a vertical orientation; and that is configurable into a storage position when not loaded with any bikes or other cargo. Such implementations may also be configurable into various intermediary states depending upon the number of bikes and extent of cargo that is desired to be held. Such implementations may also advantageously position bikes and other cargo at a distance and height relative to a vehicle trunk door to avoid obstructing the trunk door, while also providing significant ground clearance. The storage position of some implementations may provide substantially increased rear clearance, ground clearance, and trunk clearance relative to the bike rack in the fully extended position, and relative to conventional bike racks, and so may advantageously be stored as coupled to the vehicle when not in use.

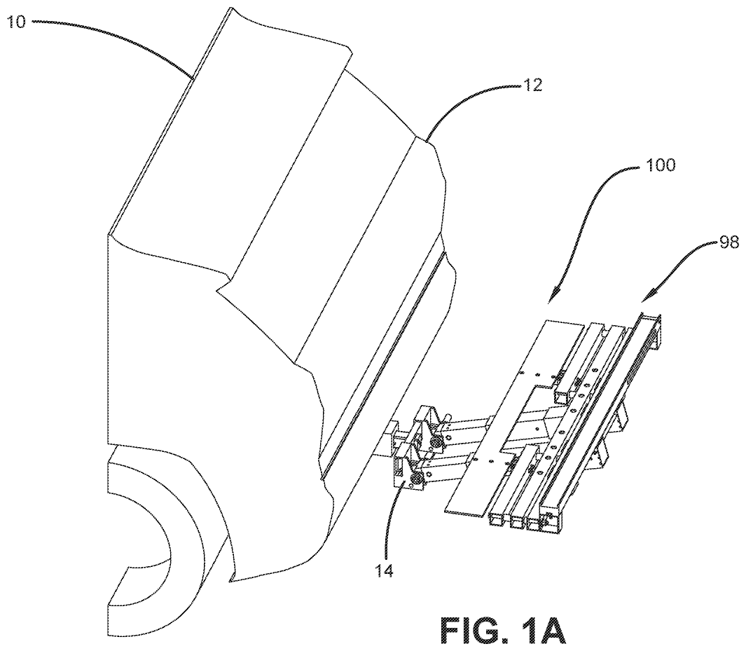

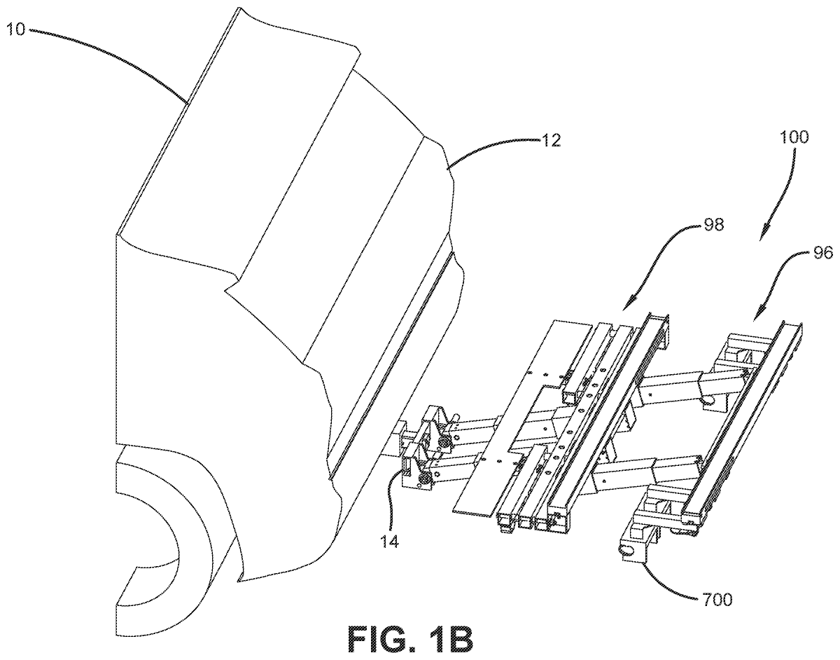

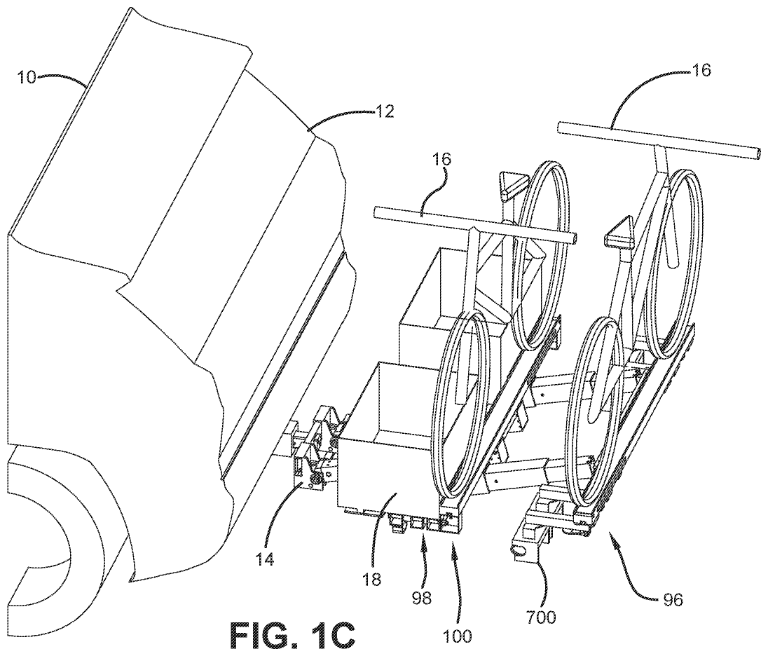

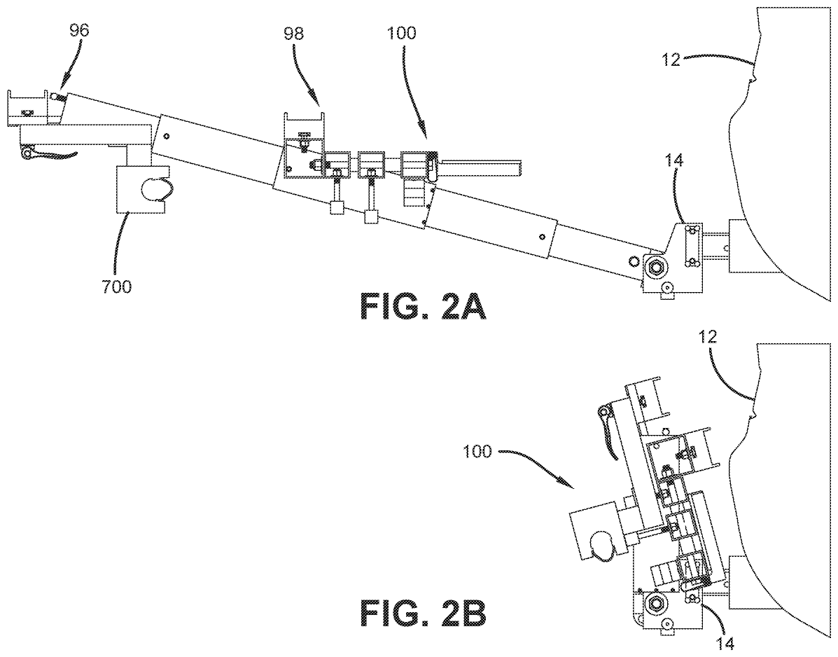

Turning now to the figures, FIG. 1A is a front perspective view of a bike rack 100 mounted to the rear of a vehicle 10 via a hitch receiver 14. The bike rack 100 of FIG. 1A includes only a first telescopic stage 98 and it is shown in a fully extended position, and in such a position, a trunk door or hatch door 12 is able to vertically rotate upwards into an open position without striking any part of the bike rack 100. FIG. 1B shows a similar view to FIG. 1A, except that the bike rack 100 utilizes both the first telescopic stage 98 and a second telescopic stage 96. FIG. 1C shows a similar view to FIG. 1B with a set of bikes 16 and a set of cargo 18 stored on the bike rack 100. Bikes 16 and cargo 18 stored on the bike rack 100 may be tied down, strapped down, clipped to, or otherwise fastened or mounted to the bike rack 100. In one or more embodiments, a first bike receiver 110 also is a bike tray that will be able to hold the bike on its own, without the need to fasten down. The hatch door 12 is also capable of fully opening without striking the bike rack 100, bikes 16, or cargo 18 as depicted in FIG. 1C, though this may vary by implementation and based upon other factors e.g., size of cargo 18, handlebar width and other characteristics of bike 16. FIG. 2A is a side elevation view of the bike rack 100 of FIG. 1B in a fully extended position, while FIG. 2B is a side elevation view of the bike rack 100 of FIG. 1B in a storage position. As can be seen in FIG. 2A, the ground clearance of the bike rack 100 is similar to that of the hitch receiver 14 at its lowest point and increases as the bike rack 100 extends away from the hitch receiver 14 to provide improved ground clearance and to prevent dragging of the bike rack 100 on the road surface on ramps or hilly terrain. While the bike rack 100 is shown and described as coupling to the hitch receiver 14, it should be understood that varying implementations of the bike rack 100 may bolt or otherwise mount directly to the vehicle frame or another part of the vehicle 10, such as an underside of the vehicle 10 or a structural member of the vehicle's rear bumper and/or impact absorbing system. Although not useable in the orientations shown in FIGS. 1A-2B, these figures also shown elements of the vertical orientation bike receiver 700, which will be discussed in greater detail below.

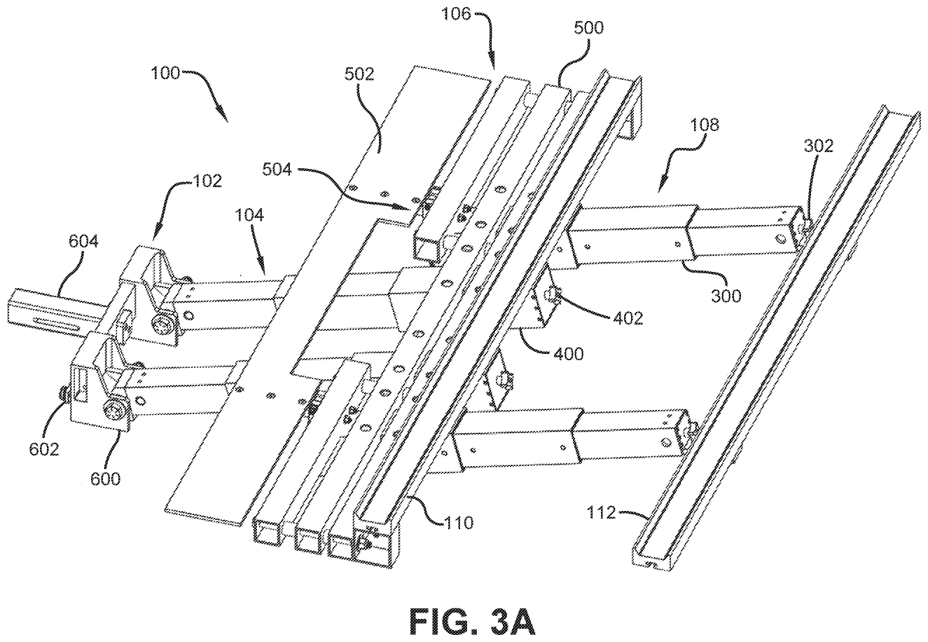

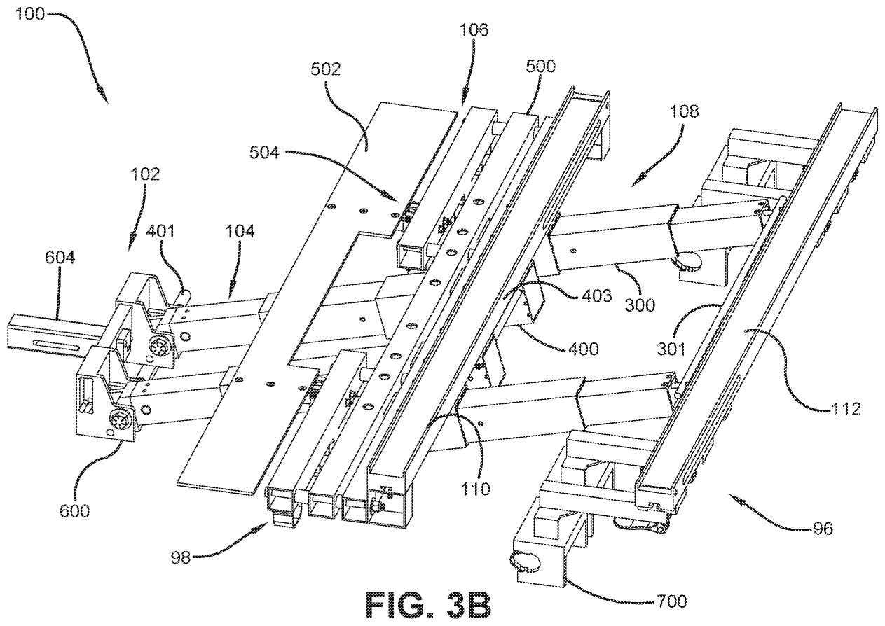

FIGS. 3A and 3B are front perspective view of the bike rack 100 that shows the bike rack 100 while not installed on a vehicle. The bike rack 100 includes a hitch assembly 102 that includes a hitch coupling 604 for mounting to a hitch receiver 14, a pivot coupling 600 that provides two rotatable connection points for a second pair of telescoping arms 104, and a hitch lock mechanism 602 (FIG. 3A only) that may be used to lock the pivot coupling 600 into one or more rotational positions. The second pair of telescoping arms 104 comprises a first and second telescoping arm 400 that are coupled to the pivot coupling 600 of the hitch assembly 102 at their proximal ends e.g., proximal relative to the vehicle 10. The embodiment shown in FIG. 3A, each telescoping arm 400 includes a position lock knob 402 at a distal end that may be used to release a position lock on the telescoping arm 400 so that it may be extended or retracted, and may be used to lock the telescoping arm 400 into one of several lengths, such that the overall length of the second pair of telescoping arms 104 may be adjusted between a minimum length e.g., between about 6 and about 24 inches and a maximum length of about three times the minimum length e.g., between about 18 and about 72 inches. The embodiment shown in FIG. 3B, the telescoping arms 400 include a grab bar 401 located within the hitch assembly 102, use of grab bar 401 compresses a pin spring (discussed and shown later) which allows the pivot blocks to freely rotate while grab bar 403 extends and retracts the telescoping arms in a similar manner as described with the embodiment shown in FIG. 3A.

Although shown in the drawings as a first telescopic stage 98 having a pair of telescoping arms 104, in one or more embodiments the first stage includes a pair of monolithic arms that are non-telescoping.

A cargo assembly 106 is coupled to the distal ends of the second pair of telescoping arms 104, such that the cargo assembly 106 extends and retracts as the length of the second pair of telescoping arms 104 is adjusted. When mounted to a vehicle on a flat road surface, the cargo assembly 106 is positioned substantially horizontally, and substantially parallel to the flat road surface. The second pair of telescoping arms 104 are coupled to the cargo assembly 106 at an angle, such that the longitudinal axis of each of the pair of telescoping arms 104 intersects with the flat road surface and the lateral axis of the cargo assembly 106. In this manner, as the second pair of telescoping arms 104 extends in length, the cargo assembly 106 remains substantially parallel to the road surface while translating outwards and upwards.

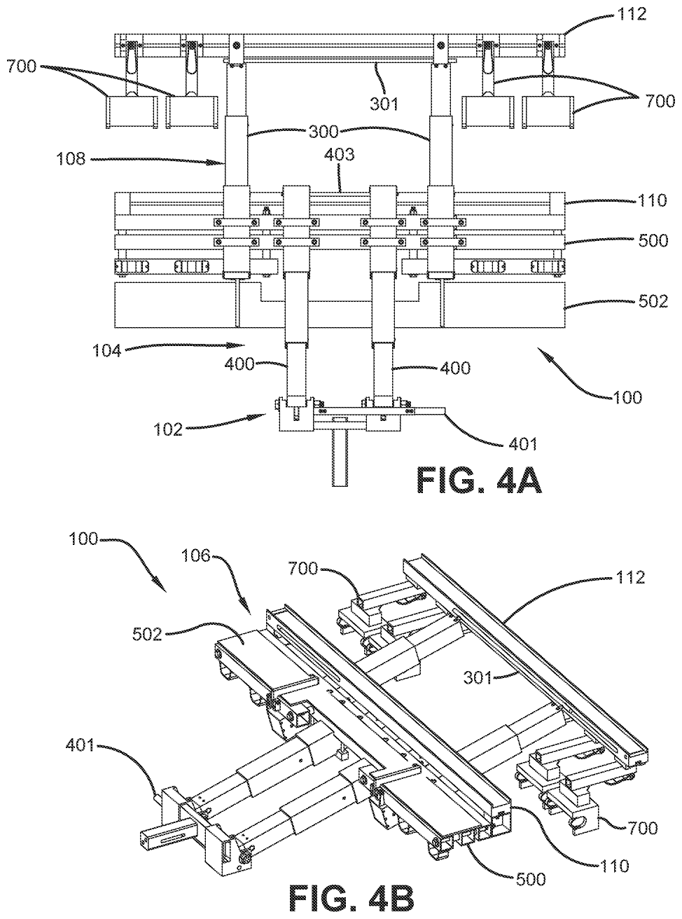

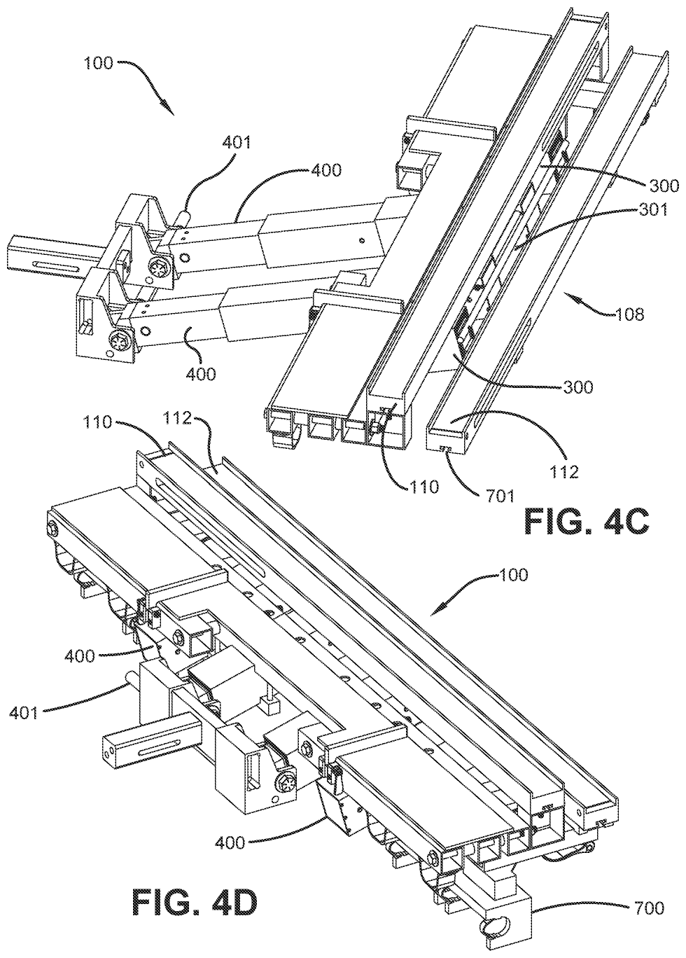

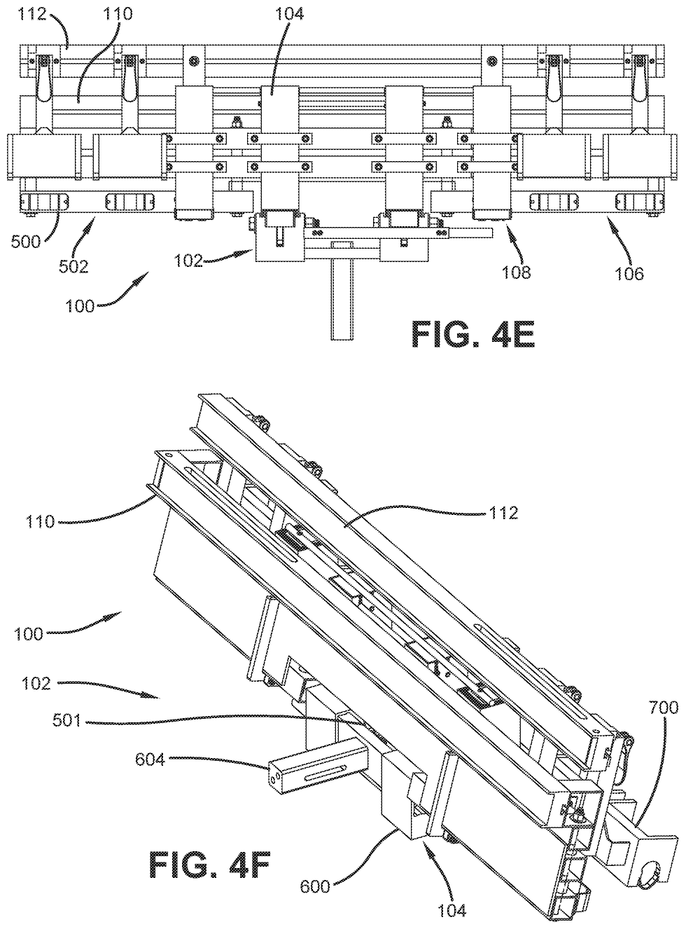

The cargo assembly 106 includes a cargo assembly frame 500 to which the second pair of telescoping arms 104 is coupled at their distal end, and that includes a first bike receiver 110 that is configured to accept and hold one or both wheels of a bike. The cargo assembly 106 also includes a foldable shelf portion 502 that is rotatably coupled to the cargo assembly frame 500 and a pair of shelf lock knobs 504 that may be used to release and lock the foldable shelf portion 502 into an extended position as it is depicted in FIGS. 3A and 3B, and that may be used to release and lock the foldable shelf portion 502 into a folded position in which the foldable shelf portion 502 rotates and lays flat against the top surface of the cargo assembly frame 500 e.g., as depicted in FIG. 4B below. The cargo assembly 106 provides a surface on which cargo may be stored during transit e.g., crates, boxes, or other cargo items, and may provide slots, holes, hooks, or other structures to which straps, ropes, cords, or other connectors or fasteners may be coupled to secure cargo stored on the cargo assembly 106. The cargo assembly 106 may also be used as a raised seating surface, bench, work surface while a vehicle is at rest, and may be useful while preparing for or completing a bike ride or other activity e.g., to provide a seating surface while changing shoes, or provide a work surface while performing maintenance on a bike.

A first pair of telescoping arms 108 is coupled to the cargo assembly frame 500 of the cargo assembly 106, in a same or similar manner as the second pair of telescoping arms 104 are coupled to the cargo assembly frame 500. In particular, the first pair of telescoping arms 108 are also coupled to the cargo assembly frame 500 at an angle, such that extension and retraction of the first pair of telescoping arms 108 occurs along an axis that intersects the lateral axis of the cargo assembly 106, while the cargo assembly 106 remains substantially parallel to the flat road surface. The first pair of telescoping arms 108 comprises a first and second telescoping arm 300. As shown in the embodiment of FIG. 3A, each telescoping arm 300 is coupled to the cargo assembly 106 at its proximal end and includes a position lock knob 302 at its distal end. As shown in the embodiment of FIG. 3B, the telescoping arms 300 are coupled to the cargo assembly 106 at its proximal end and includes a grab bar 301 at its distal end which assists in extension and retraction of the telescoping arms 300. A second bike receiver 112 is coupled to the first pair of telescoping arms 108 at their distal ends and is similarly configured as the first bike receiver 110 to receive and hold one or both wheels of a bike.

Although shown in the drawings as a second telescopic stage 96 having a pair of telescoping arms 108, in one or more embodiments the second stage includes a pair of monolithic arms that are non-telescoping.

Each telescoping arm 300 of the first pair of telescoping arms 108 and each telescoping arm 400 of the second pair of telescoping arms 104 may have a similar structure and function, including the similar or same operation of respective position lock knobs 302, 402 in FIG. 3A or the grab bars 301, 401, and 403 in FIG. 3B, similar or same coupling to the cargo assembly 106, and the similar or same range of extension and retraction e.g., from a minimum length to a maximum length of about three times the minimum length. While sharing similarities, the arms also differ in several ways. As an example, each telescoping arm 300 of the first pair of telescoping arms 108 are comprised of three nesting sections with the largest section begin positioned at the proximal end of each telescoping arm 300 and coupled to the cargo assembly 106. In a similar manner, each telescoping arm 400 of the second pair of telescoping arms 104 are comprised of three nesting sections with the largest section being positioned at the distal end of the telescoping arm 400 and coupled to the cargo assembly 106.

As has been described, the bike rack 100 may be adjusted between a fully extended position such as shown in FIG. 2A, and a storage position such as shown in FIG. 2B, and in some implementations may also be configured at varying stages of partial extension and/or retraction. FIGS. 4A through 4F illustrate examples of the bike rack 100 at varying steps between the fully extended position and the storage position. While such steps are numbered and described in sequence, it should be understood that such steps may be performed in any sequence or not at all, and in varying degrees in order to configure the bike rack 100 for a desired use. FIG. 4A is a bottom view of the bike rack 100 of FIG. 3B in a fully extended position, with the first pair of telescoping arms 108 and the second pair of telescoping arms 104 extended to their maximum length, the foldable shelf portion 502 folded down and extending from the cargo assembly frame 500, and the second pair of telescoping arms 104 rotated and locked to a lower position in the hitch assembly 102 e.g., as illustrated in FIG. 3B.

FIG. 4B is a rear profile view of the bike rack 100 of FIG. 3B after operating the pair of shelf lock knobs 504 to enable rotation of the shelf portion 502 about the connection point to the cargo assembly frame 500, and then rotating the shelf portion 502 so that it lies flat against the upper surface of the cargo assembly frame 500. In this configuration, each of the first and second bike receivers 110, 112 are usable to store a bike, and the cargo assembly 106 also provides some usable surface storage area while reducing its lateral width.

FIG. 4C is a is a front profile view of the bike rack 100 of FIG. 3B after operating the grab bar 301 of the first pair of telescoping arms 108 and applying a pushing force along the longitudinal axis of each telescoping arm 300 e.g., using the second bike receiver 112 as a handhold to cause the first pair of telescoping arms 108 to collapse or retract inwards and reduce their overall length. While the first pair of telescoping arms 108 is shown in FIG. 4C at a minimum length e.g., the first two telescoping sections are nested within the third, it should be understood that varying implementations may have one or several positions of extension or retraction at which the grab bar 301 may be operated to lock the first pair of telescoping arms 108 at a desired length. In the shown configuration, one but not both of the bike receivers 110, 112 may be used to store a bike, with the second bike receiver 112 being advantageously positioned both distally from the vehicle, and at a height below the first bike receiver 110, increasing the likelihood that storage of a bike on the second bike receiver 112 in this configuration will not obstruct use of a hatch door 12 or a car 10.

FIG. 4D is a is a rear profile view of the bike rack 100 after operating the grab bar 403 of the second pair of telescoping arms 104 and applying a pushing force along the longitudinal axis of each telescoping arm 400 e.g., using the first or second bike receiver 110, 112, or the cargo assembly 106 as a handhold to cause the second pair of telescoping arms 104 to collapse or retract inwards and reduce their overall length. While the second pair of telescoping arms 104 is shown in FIG. 4D at a minimum length e.g., the first two telescoping sections are nested within the third, it should be understood that varying implementations may have one or several positions of extension or retraction at which the grab bar 403 may be operated to lock the second pair of telescoping arms 104 at a desired length. In the shown configuration, one but not both of the bike receivers 110, 112 may be used to store a bike, with the second bike receiver 112 being advantageously positioned both distally from the vehicle, and at a height below the first bike receiver 110, increasing the likelihood that storage of a bike on the second bike receiver 112 in this configuration will not obstruct use of the hatch door 12.

FIG. 4E is a bottom view of the bike rack 100 while configured as illustrated in FIG. 4D. In FIG. 4E, it can be seen that the first pair of telescoping arms 108 and second pair of telescoping arms 104 are positioned at their minimum length, greatly reducing the distance to which the bike rack 100 extends outwards from a vehicle to which it is mounted. In FIG. 4E, it can also be seen that folding of the shelf portion 502 to lie flat upon the cargo assembly frame 500 allows for the cargo assembly 106 to retract to a position proximate the hitch assembly 102 without striking or being obstructed by the vehicle or the hitch assembly 102 e.g., a cutout portion 501 of the shelf portion 502 receives the hitch assembly 102 as the cargo assembly 106 is retracted and/or rotated, as illustrated in FIG. 4F.

FIG. 4F is a rear profile view of the bike rack 100 in the storage position, after operating the grab bar 401 and rotating the second pair of telescoping arms 104 upwards e.g., using the cargo assembly 106 or bike receiver 112 as a handhold from a lower position in the hitch assembly 102 to an upper position in the hitch assembly 102. While the bike rack 100 does not provide storage capabilities for a bike or cargo in this configuration, its overall shape and reduced dimensions result in increased rear clearance for the vehicle 10 and sufficient clearance for operation of the trunk 12, such that the bike rack 100 may be stored on the vehicle 10 in the storage position without significant disadvantage.

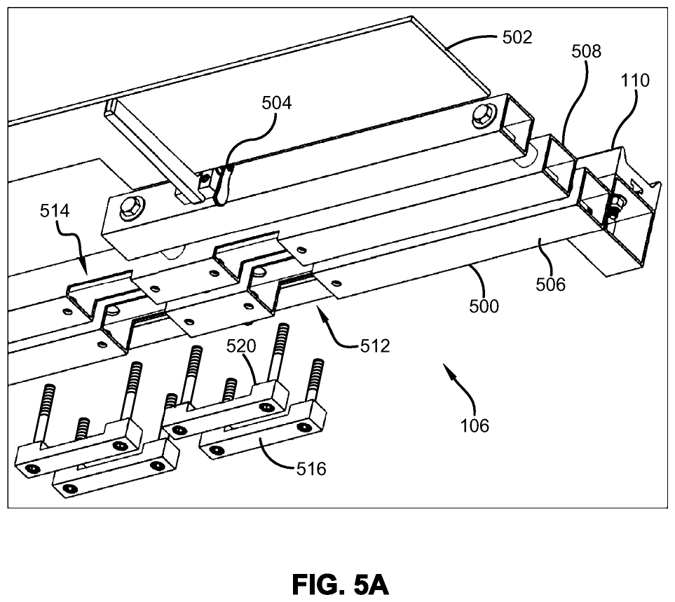

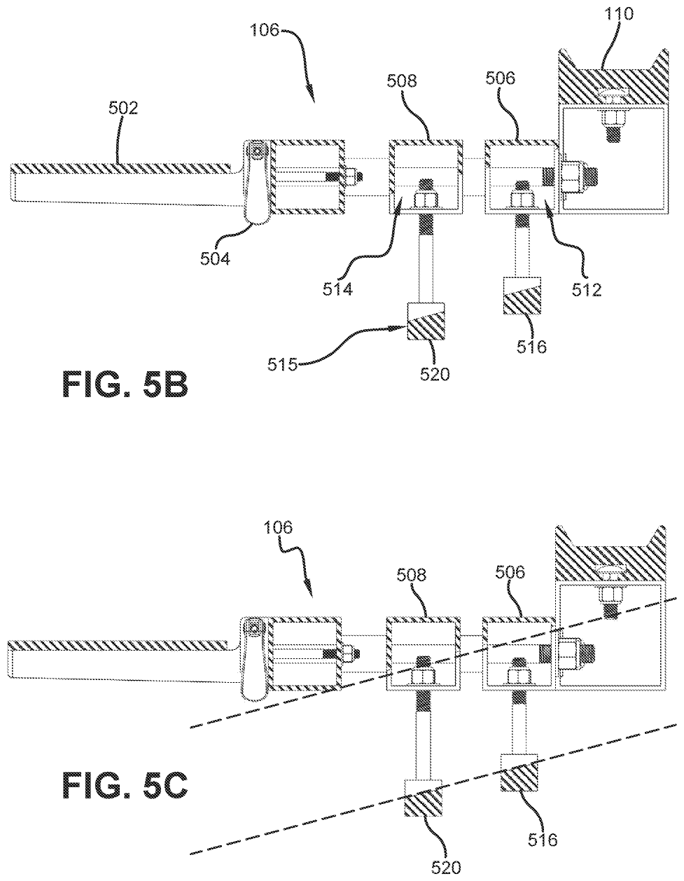

FIG. 5A is a bottom profile view of the cargo assembly 106 with both pairs of telescoping arms 104, 108 detached. The cargo assembly frame 500 includes a first frame member 506 and a second frame member 508 to which the telescoping arms mount when assembled. The first and second frame member 506, 508 are each hollow, and may include mounting holes or other fixtures to which a set of brackets 516, 520 may be attached to secure the telescoping arms to the cargo assembly frame. The first frame member 506 includes a first angled cutout 512 for each telescoping arm, and the second frame member 508 includes a second angled cutout 514 for each telescoping arm. Each cutout 512, 514 is configured to receive a corresponding bracket 516, 520 in order to provide the angular coupling of telescoping arms to the cargo assembly frame 500, as is more clearly illustrated by FIGS. 5B and 5C.

FIG. 5B is a side elevation cross sectional view of the cargo assembly 106, taken along the center of the brackets 516, 520. As can be seen, the first angled cutout 512 of the first frame member 506 has a differing cutout height between the right side and the left side of the first frame member 506, and the second angled cutout 514 of the second frame member 508 has a different cutout height between the right side and the left side of the second frame member 508. Additionally, it can be seen that a first bracket 516 and a second bracket 520 include mounting bolts of different lengths, such that each bracket mounts to its respective frame member 506, 508 at different height relative to each other. It can further be seen that each of the first bracket 516 and the second bracket 520 include an angled interior surface 515 that engages with the housing of a telescoping arm when mounted to the cargo assembly frame 500.

This combination of features described above provides a structure for the angular coupling of the first and second pair of telescoping arms 104, 108 to the cargo assembly frame 500 as illustrated by FIG. 5C, which includes an overlaid set of dashed lines illustrating the angled mounting point for a telescoping arm. In this manner, a telescoping arm of varying dimensions can be accommodated by varying the height of cutouts of the first and second frame members 506, 508, or by varying the length of bolts used by first and second brackets 516, 520, or both. Similarly, a desired coupling angle of each pair of telescoping arms 104, 108 may be accommodated by varying the cutout height difference between the right side and the left side of cutouts for the first and second frame members 506, 508, by varying the angle of the angled interior surface 515 of the first and second brackets 516, 620, or both.

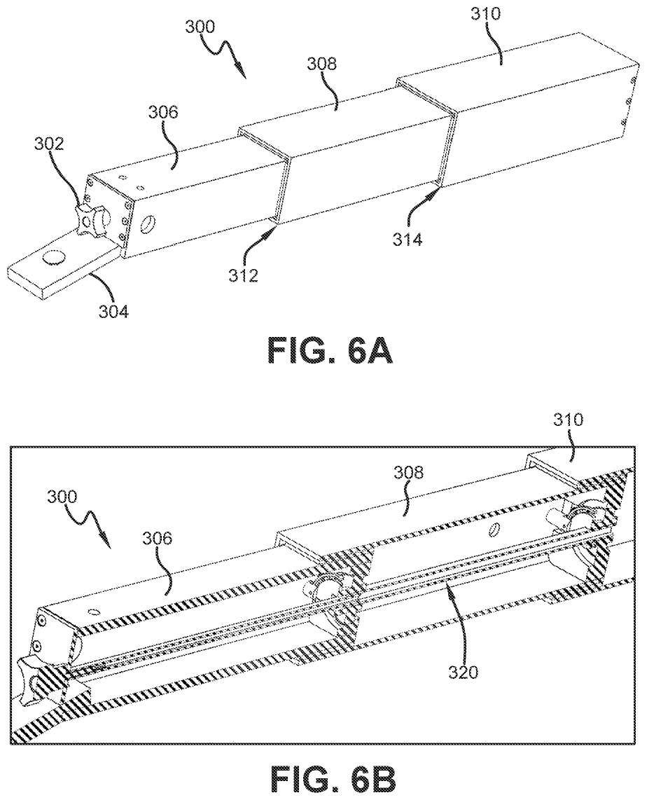

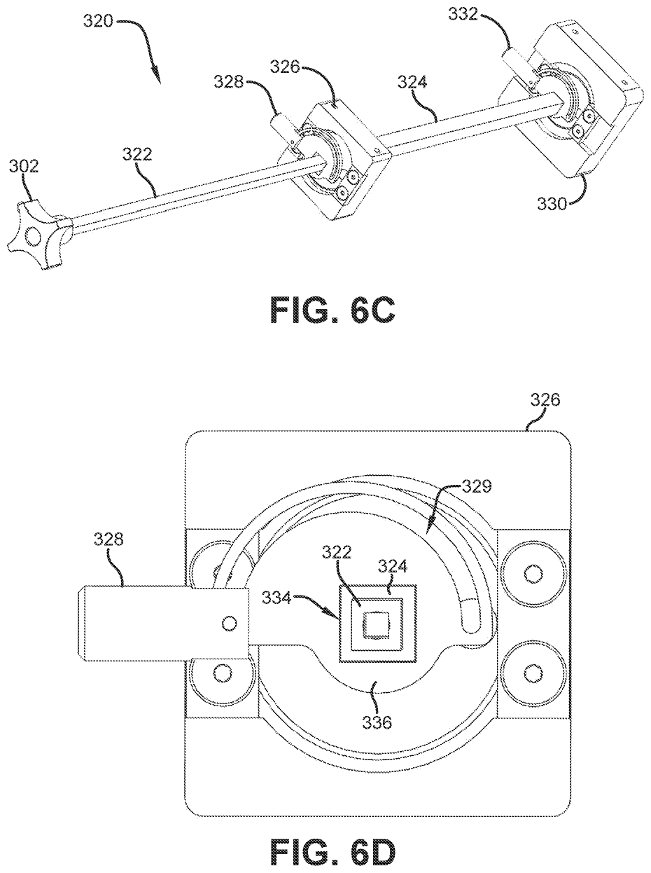

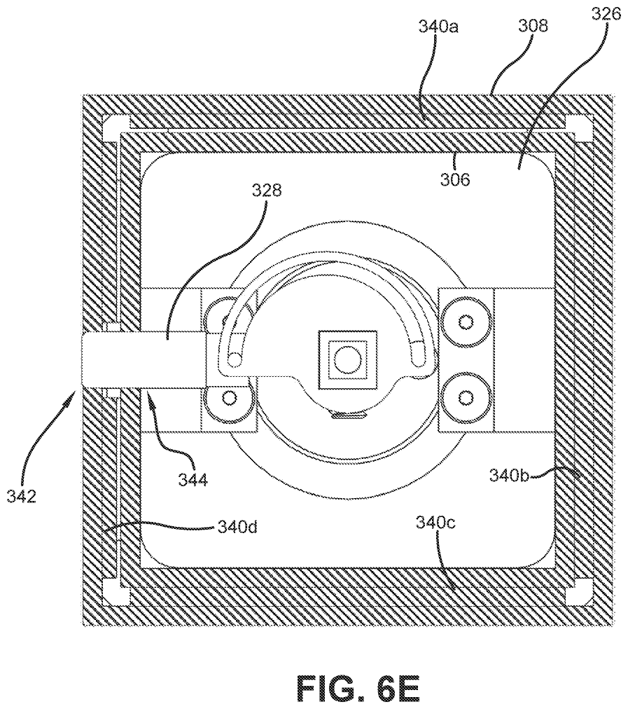

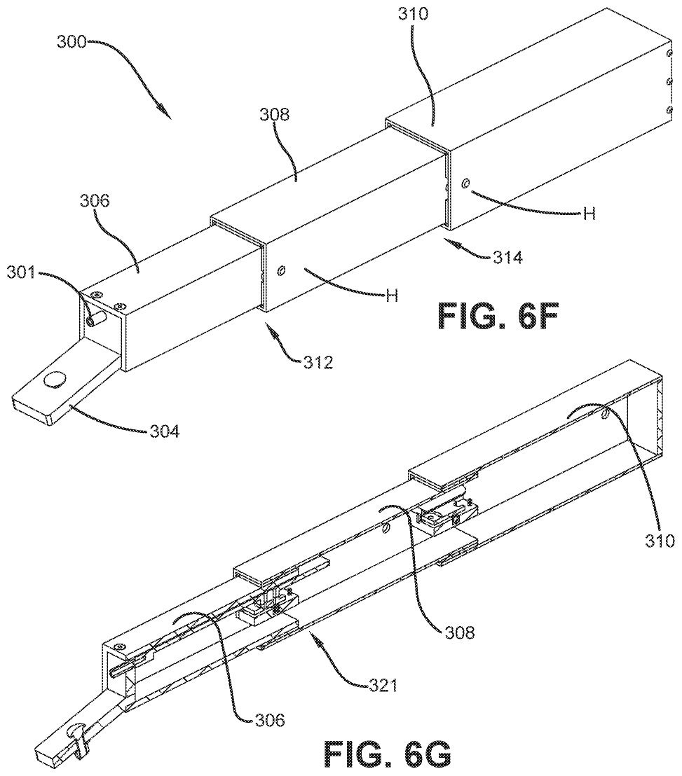

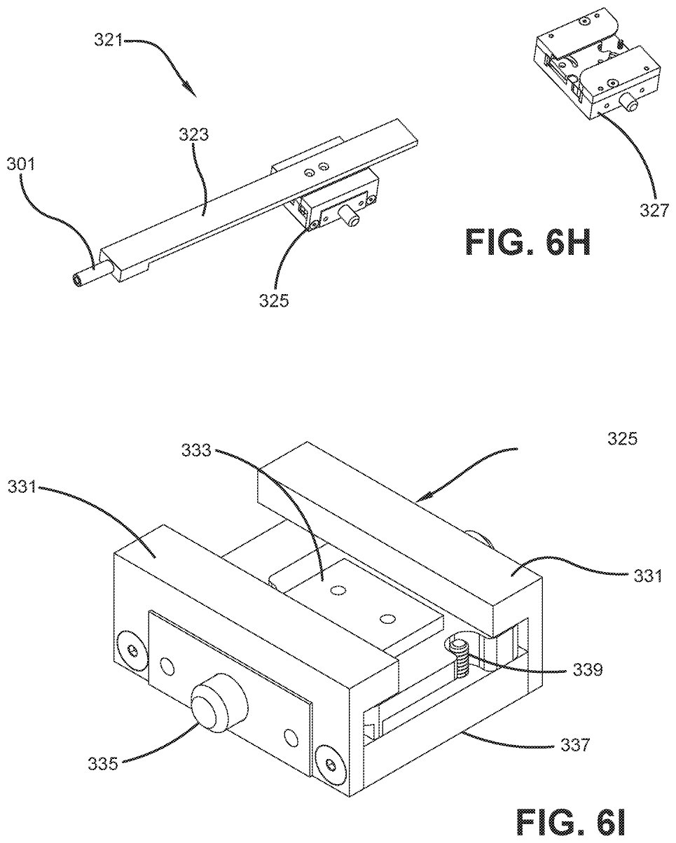

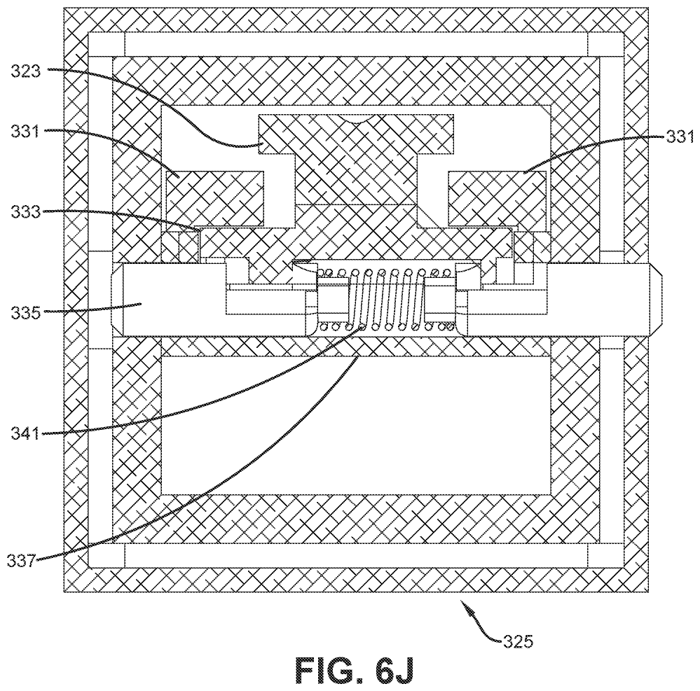

FIG. 6A is a front perspective view of a telescoping arm 300 of the first pair of telescoping arms 108 as utilized in the bike rack 100 of FIG. 3A. The telescoping arm 300 includes a bike receiver bracket 304 at a distal end to which the second bike receiver 112 may be mounted. The telescoping arm 300 also includes a first portion 306, a second portion 308, and a third portion 310 that are sized and shaped to nest within each other and allow for extension and retraction when the position lock knob 302 is operated and a corresponding force is applied. The telescoping arm 300 may also include a first set of wear pads 312 positioned at a coupling of the first portion 306 and second portion 308 and a second set of wear pads 314 positioned at a coupling of the second portion 308 and the third portion 310. Each set of wear pads 312, 314 may include four wear pads e.g., one positioned on each side of the portion at the connection point. Such wear pads may be fixed onto one of the portions and slidably engaged with a corresponding portion and may be formed of a material that reduces friction and metal-to-metal contact during length adjustment of the telescoping arm 300, such as plastics, fibers, synthetic fibers, and other materials. As an alternative or addition to wear pads, the telescoping arm 300 may also include ball bearings, greased rails, or other mechanical means for reducing the force required to extend and retract the nested sections.

FIG. 6B is a cross sectional view of the telescoping arm 300 of FIG. 6A, in which a locking mechanism 320 is visible within the arm 300. The locking mechanism 320 is operable via the position lock knob 302 to engage and disengage a set of locks at each section coupling point of the telescoping arm 300 e.g., at the base of the first portion 306, and the base of the second portion 308. FIG. 6C is a front perspective view of the locking mechanism 320 isolated from the telescoping arm 300. The locking mechanism 320 includes a first shaft 322 and a second shaft 324 that are linearly coupled to the position lock knob 302 and rotate therewith, and the first shaft 322 is sized and positioned to nest within and extend from the second shaft 324 as the telescoping member is retracted or extended. A first cam mechanism 326 includes a first lock bolt 328 and is configured to linearly retract and extend the first lock bolt 328 by rotation of the position lock knob 302.

As the first lock bolt 328 retracts, it disengages from a corresponding aligned slot in the first portion 306 and second portion 308 of arm 300, allowing for those portions to move independently of each other. The first lock bolt 328 may then be extended to engage with a different corresponding aligned slot in the first portion 306 and the second portion 308 of arm 300, to lock the portions together and prevent independent movement. The number and position of slots in the first and second portions 306, 308 may be varied to provide a desired flexibility in position between full extension and full retraction of the telescoping arm 300. The first cam mechanism 326 may be engaged and disengaged by opposite rotations of the position lock knob 302 and may also be configured to include a spring or other biasing means to cause the cam mechanism to bias towards an engaged or locked position. The locking mechanism 320 also includes a second cam mechanism 330 that includes a second lock bolt 332, and that functions similarly to the first cam mechanism 326, while having a different overall size, and a different length of lock bolt 332 corresponding to the increased dimensions of the third portion 310.

FIG. 6D is a plan view of the first cam mechanism 326, which itself is similar to the second cam mechanism 330. The first cam mechanism 326 includes a cam plate 336 that is engaged with the nested first and second shaft 322, 324 which pass through a shaft slot 334, and configured to rotate by operation of the position lock knob 302. As the cam plate 336 rotates, the first lock bolt 328, which is slidably engaged with the cam plate 336 by a pin within a cam slot 329, will extend and retract by operation of the cam slot's 329 offset from the rotational axis of the cam plate 336. FIG. 6E is a cross sectional view of the cam mechanism 326 within the telescoping arm 300, illustrating the engagement of the first lock bolt 328 with the first and second portions 306, 308. A set of wear pads are also visible in the cross-sectional view, including a first, second, third, and fourth wear pad 340a, 340b, 340c, 340d that are fixed to each interior wall of the second portion 308 and slidably engaged with the exterior wall of the first portion 306 to reduce friction, ease length adjustment, and reduce wiggle and play between the portions. The first lock bolt 328 is shown in an extended position, with the distal tip of the first lock bolt 328 passing through a slot 344 in the sidewall of the first portion 306 and a slot 342 in a sidewall of the second portion 308, thereby locking the engaged portions together at their current relative positions.

FIG. 6F is a front perspective view of a telescoping arm 300 of the first pair of telescoping arms 108 as utilized in the bike rack 100 of FIG. 3B. The telescoping arm 300 includes a bike receiver bracket 304 at a distal end to which the second bike receiver 112 may be mounted. The telescoping arm 300 also includes a first portion 306, a second portion 308, and a third portion 310 that are sized and shaped to nest within each other and allow for extension and retraction when the grab bar 301 is operated and a corresponding force is applied. The telescoping arm 300 may also include a first set of wear pads 312 positioned at a coupling of the first portion 306 and second portion 308 and a second set of wear pads 314 positioned at a coupling of the second portion 308 and the third portion 310. Each set of wear pads 312, 314 may include four wear pads e.g., one positioned on each side of the portion at the connection point. Such wear pads may be fixed onto one of the portions and slidably engaged with a corresponding portion and may be formed of a material that reduces friction and metal-to-metal contact during length adjustment of the telescoping arm 300, such as plastics, fibers, synthetic fibers, and other materials. As an alternative or addition to wear pads, the telescoping arm 300 may also include ball bearings, greased rails, or other mechanical means for reducing the force required to extend and retract the nested sections.

FIG. 6G is a cross sectional view of the telescoping arm 300 of FIG. 6F, in which a locking mechanism 320 is visible within the arm 300. The locking mechanism 321 is operable via the grab bar 301 to engage and disengage a set of locks at each section coupling point of the telescoping arm 300 e.g., at the base of the first portion 306, and the base of the second portion 308. FIG. 6H is a front perspective view of the locking mechanism 321 isolated from the telescoping arm 300. The locking mechanism 321 includes a pin lock actuator bar 323 that is linearly coupled to the grab bar 301. The shaft 323 is sized and positioned to interact with the first and second locking mechanisms 325 and 327 as the telescoping arm 300 is retracted or extended. In one or more embodiments, the first locking mechanism 325 is referred to as the small-tube locking mechanism 325 and the second locking mechanism 327 is referred to as the large-tube locking mechanism 327.

FIG. 6I is a front perspective view of the first locking mechanism 325, which itself is similar to the second locking mechanism 327. The first locking mechanism includes a first and second slider cap plate 331, a slider 333, locking pins 335, and a locking pin housing 337. Housing 337 has a bore that contains two opposing locking pins 335 with a compression spring 341 there between. Slider 333 slides across a top surface of housing 337, interacting with the locking pins 335 as it moves. A boss (not shown) on one side of the housing 337 limits movement of the slider 333 in one direction while a screw 339 limits movement in the opposite direction while allowing for assembly/disassembly of the locking mechanism 325. Slider cap plates 331 act as side and vertical guides for the slider 333, limiting its motion to being perpendicular to the locking pins 335. In one or more embodiments, slider cap plates 331 can be lined with a material, such as but not limited to, an ultra-high molecular weight polyethylene, to reduce friction between the slider cap plates 331 and the slider 333.

FIG. 6J is a cross sectional view of the first locking mechanism 325 within the telescoping arm 300, illustrating further components of the first locking mechanism. Those further components include the pin lock actuator bar 323 and the pin spring 341. FIG. 6J shows how those components interact with the first and second slider cap plates 331, the slider 333, the locking pins 335, and the locking pin housing 337. The pin lock actuator bar 323 screws to the slider 333 and extends to the grab bar 301 where the user can push and pull on it to actuate the mechanism 325. As the user pushes and pulls on the grab bar 301, the slider 333 slides perpendicular to the locking pins 335. In one or more embodiments, on the bottom of the slider 333 are ramped wedge profiles that dictate the axial position of pins 335. The spring 341 is coaxial to the locking pins 335 such that it pushes the spring 341 out when the slider 333 is in the appropriate position. The pins 335 align with holes H in the tube 300 when in an extended position. The opposite pin 335 aligns with holes on the opposite side and opposite end of the tube 300 in the retracted position.

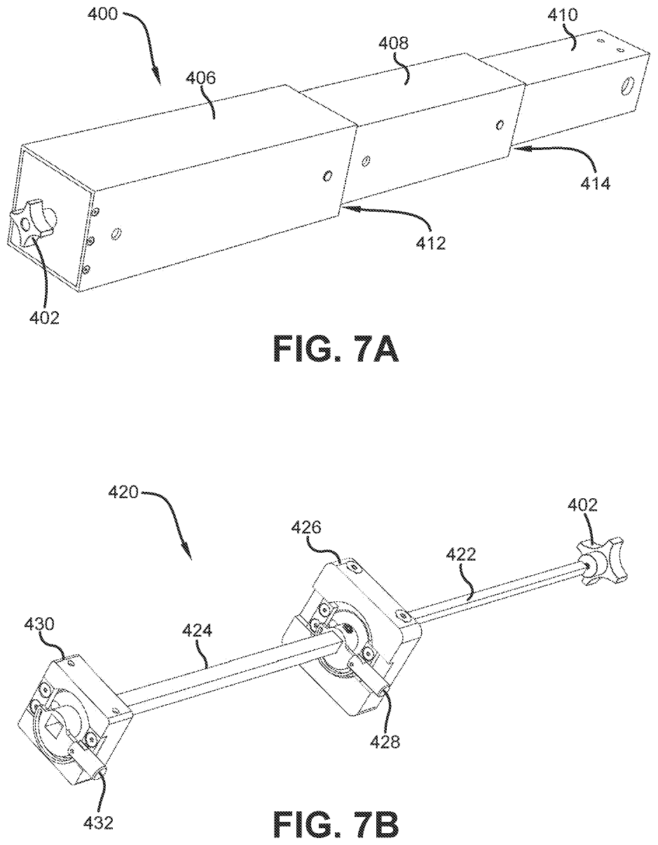

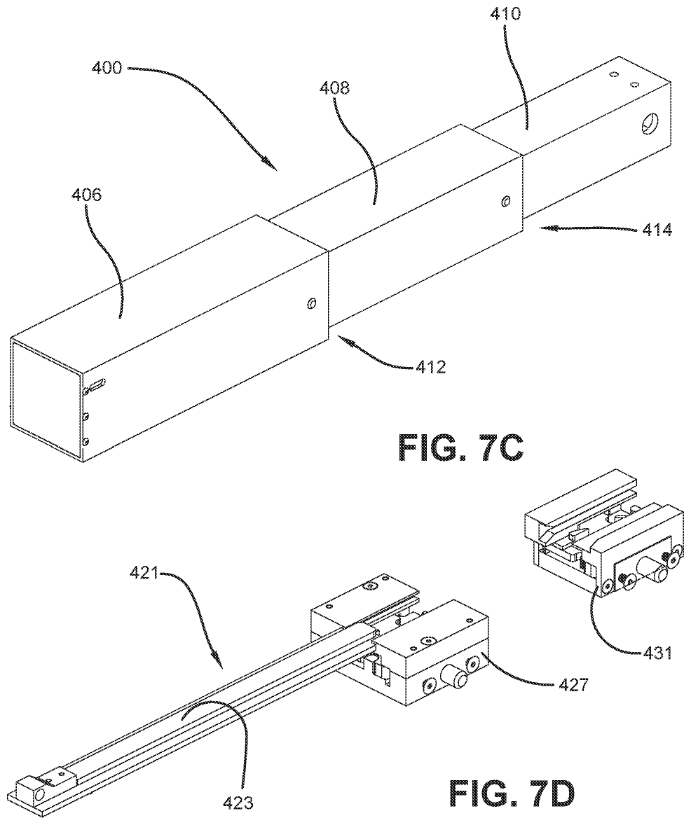

FIG. 7A is a front perspective view of the telescoping arm 400 of the second pair of telescoping arms 104 of FIG. 3A. As has been described, the telescoping arm 400 shares similarities with the telescoping arm 300, but it is also distinct in at least the arrangement of nested portions and other features. The telescoping arm 400 includes a first portion 406, second portion 408, and third portion 410 that are slidably coupled to each other to allow for nesting retraction and extension, and that include sets of wear pads 412, 414 at slidable engagement points, as has been described in the context of the telescoping arm 300 of FIG. 6A.

FIG. 7B is a rear perspective view of a locking mechanism 420 isolated from the telescoping arm 400 and having a similar function as the locking mechanism 320 of FIG. 6B. The locking mechanism 420 includes a first and second cam mechanism 426, 430, having a first and second lock bolt 428, 432, and each rotatably engaged with a first and second shaft nested shaft 422, 424 that are operated by rotation of the position lock knob 402, as has been described above in the context of FIG. 6B. While sharing similarities with the prior disclosed locking mechanism 320, that of FIG. 7B differs in the size and sequence of cam mechanisms 426, 430 to accommodate for the different size and sequence of nesting portions 406, 408, 410 of the telescoping arm 400.

FIG. 7C is a front perspective view of the telescoping arm 400 of the second pair of telescoping arms 104 of FIG. 3B. As has been described, the telescoping arm 400 shares similarities with the telescoping arm 300, but it is also distinct in at least the arrangement of the nested portions and other features. The telescoping arm 400 includes a first portion 406, second portion 408, and third portion 410 that are slidably coupled to each other to allow for nesting retraction and extension, and that include sets of wear pads 412, 414 at slidable engagement points, as has been described in the context of the telescoping arm 300 of FIG. 6F.

FIG. 7D is a rear perspective view of a locking mechanism 421 isolated from the telescoping arm 400 and having a similar function as the locking mechanism 321 of FIG. 6G. The locking mechanism 421 includes a first and second locking mechanism 427, 431, which are each engageable with a pin lock actuator bar 423 that is operated by grab bar 401 (not shown), as has been described above in the context of FIG. 6G. While sharing similarities with the prior disclosed locking mechanism 321, locking mechanism 421 differs in the size and sequence of the first and second locking sleds 427, 431 to accommodate for the different size and sequencing of the nesting portions 406, 408, and 410 of the telescoping arm 400. In one or more embodiments, actuator bar 423 is not screwed to the slider as with actuator bar 323, such that actuator bar 423 can move relative to the slider. Actuator bar 423 therefore moves with the slide via small bosses on the bottom of bar 423 that catch on the slider of locking mechanism 421.

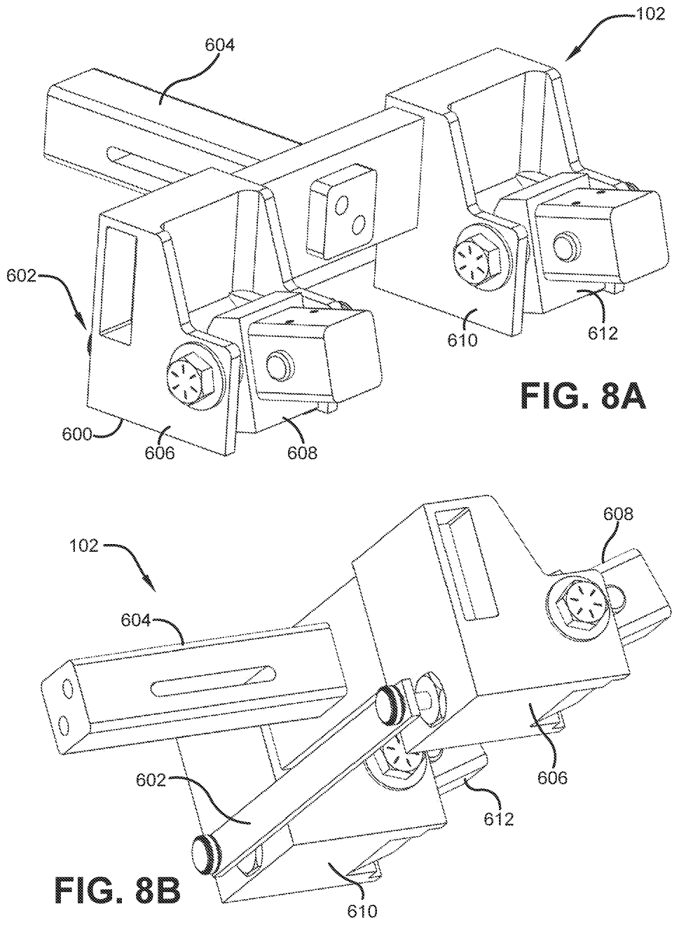

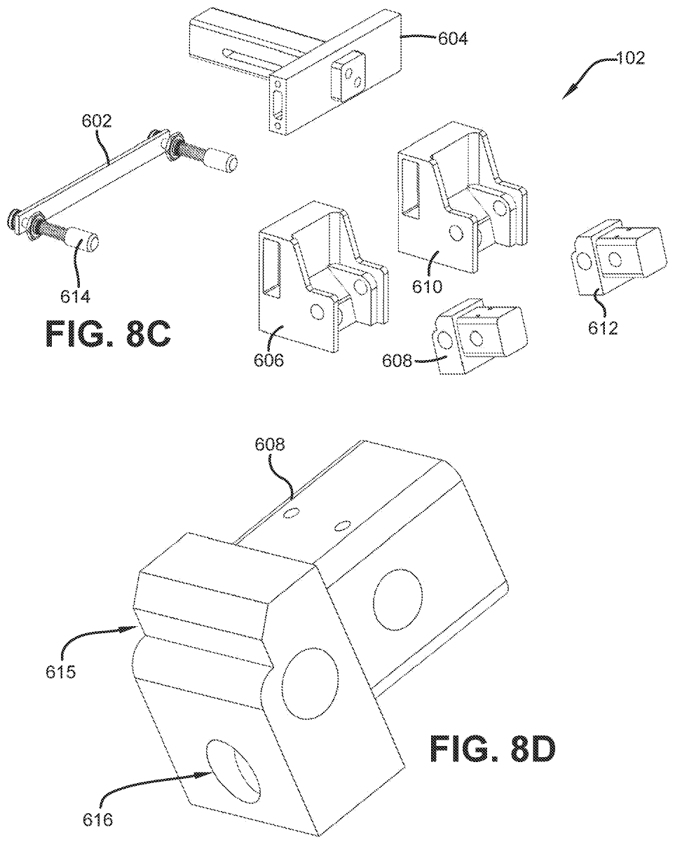

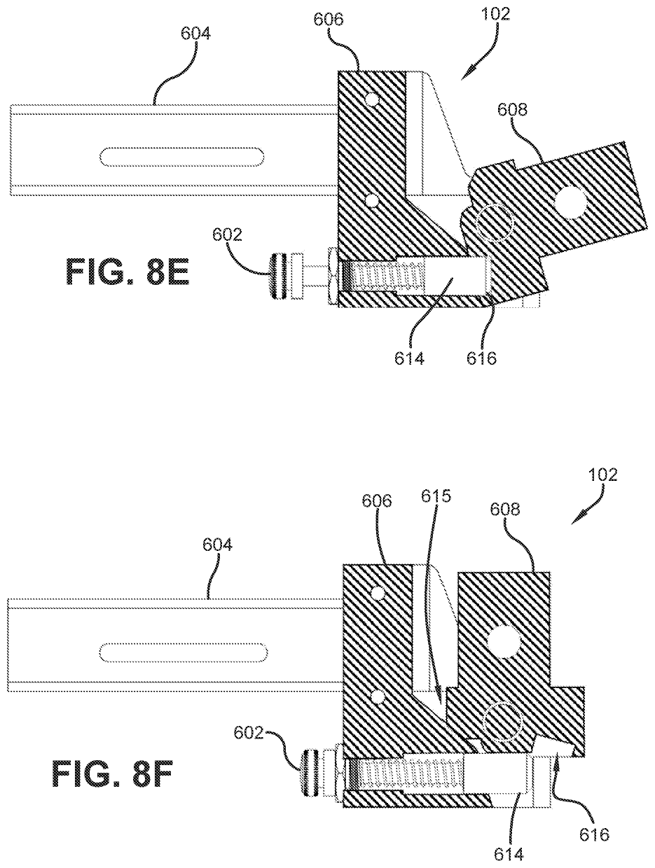

FIG. 8A is a front perspective view of a first embodiment of hitch assembly 102. The hitch assembly 102 includes a hitch coupling 604 that may be sized and shaped to fit with varying hitch receivers 14, or that may be replaced by a mounting structure to mount the hitch assembly 102 directly to a frame or other structure of a vehicle. The pivot coupling 600 includes a pair of pivot housings 606, 610 in which a pair of pivot mounts 608, 612 are rotatably mounted. The pivot mounts 608, 612 may be coupled to the proximal ends of the first pair of telescoping arms 104 to allow for rotation of the bike rack into the storage position. FIG. 8B is a rear perspective view of the hitch assembly 102, in which an embodiment of a hitch lock mechanism 602 is visible. FIG. 8C is an exploded view showing several components of the hitch assembly 102 in isolation, including the hitch lock mechanism 602, the pivot housings 606, 610, the pivot mounts 608, 612, and the hitch coupling 604. The hitch lock mechanism 602 includes a pair of lock bolts 614, and each lock bolt 614 is slidably mounted within a crossbar of the hitch lock mechanism 602 to allow for extension and retraction and is spring biased towards an extended position.

FIG. 8D is a rear profile view of the pivot mount 608, showing a lock bolt slot 616 and a beveled edge 615. The lock bolt slot 616 is positioned and shaped to receive and engage with the lock bolt 614 of the hitch lock mechanism when the pivot mount 608 is in the lower rotational position. The beveled edge 615 is configured to allow the pivot mount 608 to rotate within the pivot housing 606 between a lower rotational position and an upper rotational position. The preceding is illustrated more clearly by FIGS. 8E and 8F, which illustrate in cross sectional view, taken along the center of the lock bolt slot, the pivot mount 608 at a first rotational position e.g., the lower position and second rotational position e.g., the upper position respectively. In FIG. 8E, the lock bolt 614 is partially extended and received by the lock bolt slot 616 of the pivot mount 608 in the first rotational position. The hitch lock mechanism 602 may be operated by pushing or pulling on the cross bar to retract the lock bolt 614 from the lock bolt slot 616, and the pivot mount 608 may then be rotated upwards into the second rotational position where the beveled edge 615 strikes a corresponding surface of the pivot housing 606. In the second rotational position, the lock bolt 614 may be fully extended by operation of the hitch lock mechanism 602. When fully extended, the lock bolt 614 rests under the pivot mount 608 and prevents rotation back to the first rotational position.

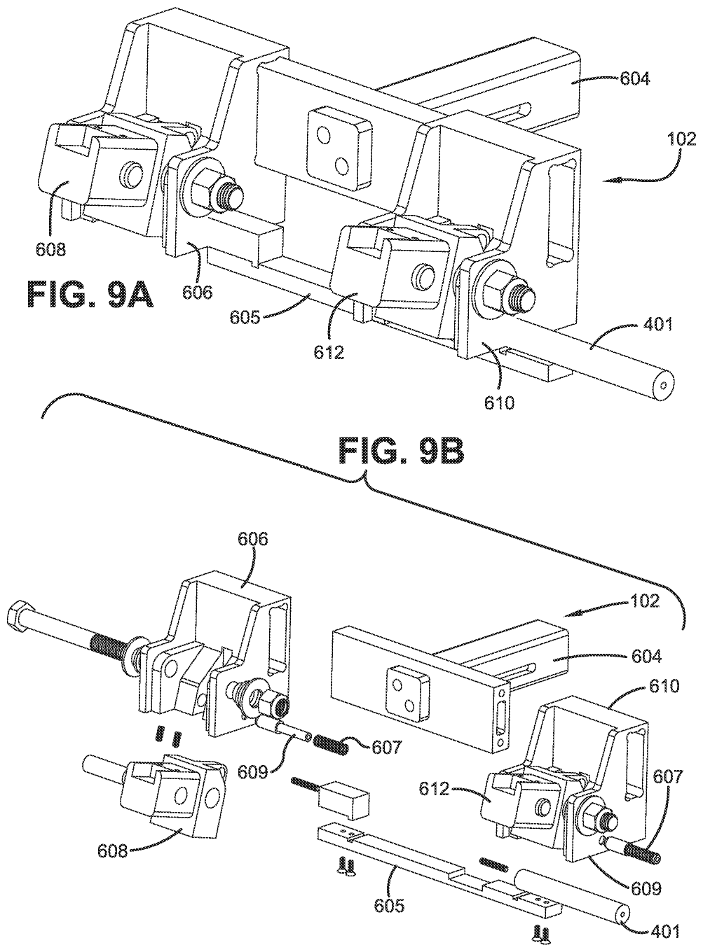

FIG. 9A is a front perspective view of a second embodiment of hitch assembly 102. The hitch assembly 102 includes a hitch coupling 604 that may be sized and shaped to fit with varying hitch receivers 14, or that may be replaced by a mounting structure to mount the hitch assembly 102 directly to a frame or other structure of a vehicle. The pivot coupling 600 includes a pair of pivot housings 606, 610 in which a pair of pivot mounts 608, 612 are rotatably mounted. The pivot mounts 608, 612 may be coupled to the proximal ends of the first pair of telescoping arms 104 to allow for rotation of the bike rack 100 into the storage position. FIG. 9B is an exploded view showing several components of the hitch assembly 102 in isolation, including the pivot housings 606, 610, the pivot mounts 608, 612, and the hitch coupling 604 grab bar 401, actuator bar 605, a plurality of springs 607, and a plurality of pins 609 to allow for rotation of the pivot mounts upwards or downwards. The user grabs the grab bar 401 sticking out of the side of the assembly 102 and pulls, this action releases the pins 609 allowing the user to begin lifting the rack 100 up or down. The pins 609 will automatically go back to a closed position with biasing of the springs 607. The pins 609 are engaged with the pivot mounts 608, 612 rather than from the rear of the assembly 102 as shown in FIG. 8A.

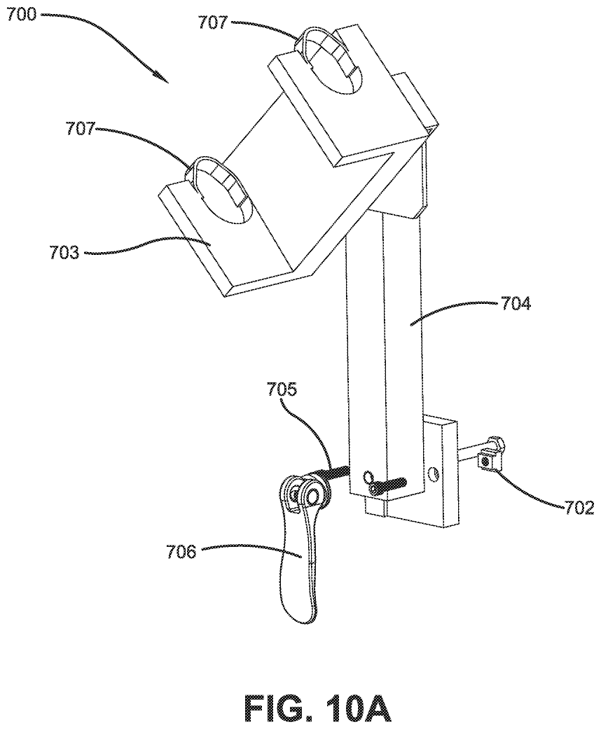

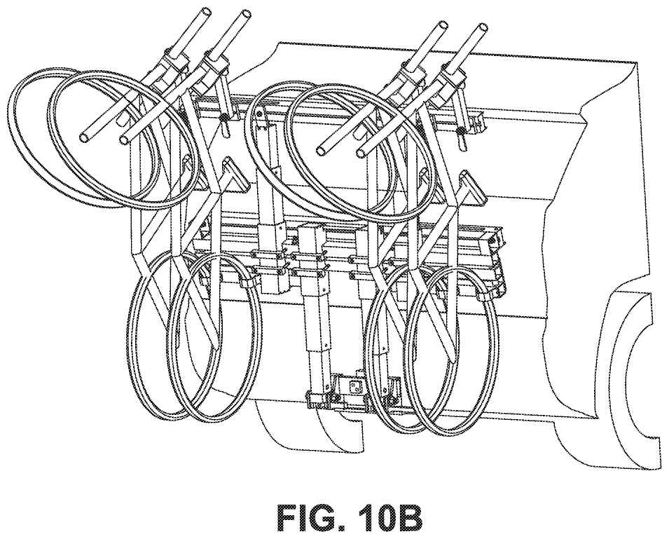

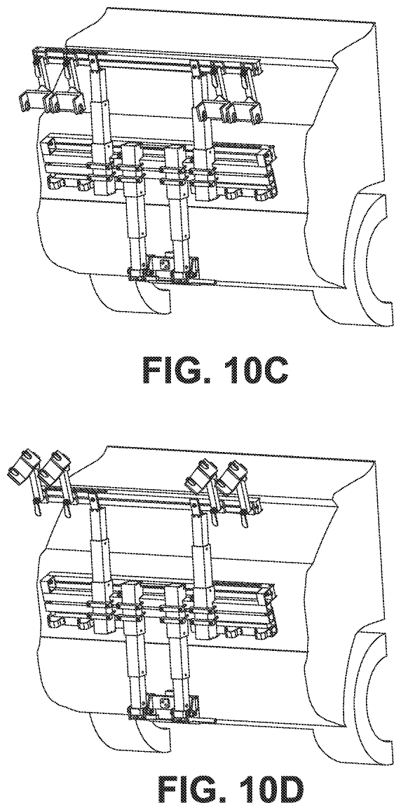

FIG. 10A is a perspective view of a vertical orientation bike receiver 700. As shown in various embodiments, the vertical orientation bike receivers 700 are mounted to a bottom surface of the second bike receiver 112 via a t-slot 701 (such as shown in FIG. 4C) and a t-nut 702. The vertical orientation bike receiver 700 includes a cradle 703 mounted on a cradle arm 704. The cradle arm 704 pivots around a bolt 705 that is locked in place via a cam lock handle 706. A bike's handle bars are secured to the cradle 703 via two flexible straps 707. In more than one embodiment, the cradle 703 is mounted to the cradle arm 704 at a 35-degree angle to allow handle bar clearable for multiple bikes when mounted, such as shown in FIG. 10B. FIG. 10C shows the cradle arms 704 pivoted down in a stowed away position, and FIG. 10D shows the cradle arms 704 pivoted up in an extended storage position.

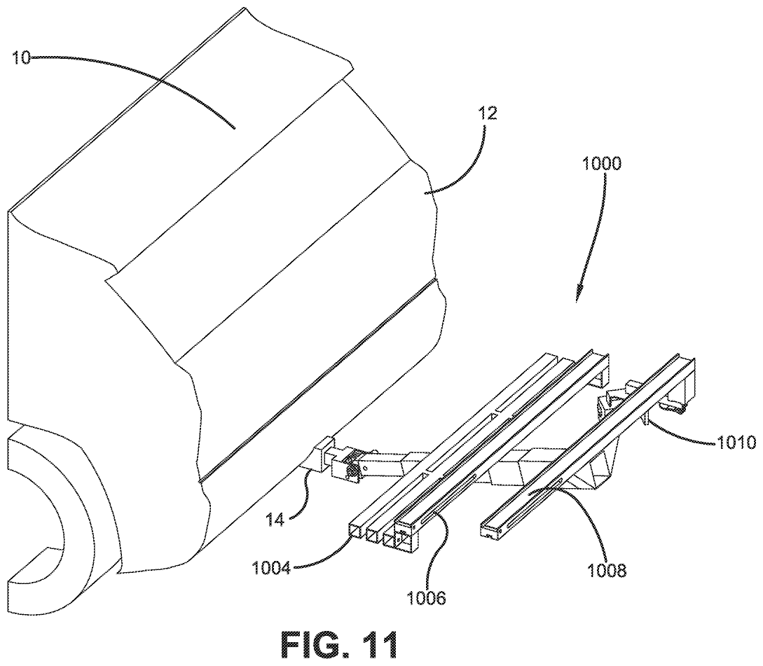

FIG. 11 is a front perspective view of a bike rack 1000 that shows the bike rack 1000 mounted to the rear of a vehicle 10 via a hitch receiver 14. The bike rack 1000 includes a single telescopic arm 1002 and it is shown in a fully extended position, and in such a position, a trunk door or hatch door 12 is able to vertically rotate upwards into an open position without striking any part of the bike rack 1000. Similar to bike rack 100, bike rack 1000 includes a cargo assembly 1004, a first bike receiver 1006, a second bike receiver 1008, and at least one vertical orientation bike receiver 1010. Although not shown in detail, the single telescopic arm 1002 includes multiple portions that are sized and shaped to nest within each other and allow for extension and retraction when an actuation assembly is operated, and corresponding force is applied.

Although bike rack 1000 is shown with a single telescopic arm 1002, in one or more embodiments, bike rack 1000 includes a single monolithic arm that is non-telescoping.

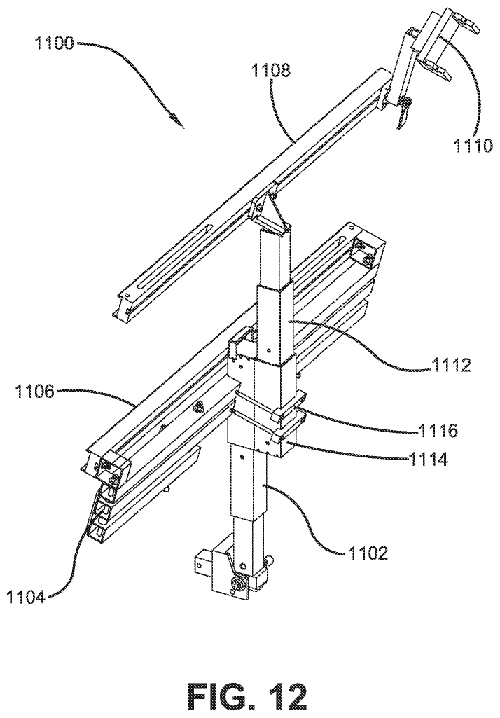

FIG. 12 is a side perspective view of a bike rack 1100. The bike rack 1100 includes a first telescopic arm 1102 and a second telescopic arm 1112. Similar to bike rack 100 and 1000, bike rack 1100 includes a cargo assembly 1104, a first bike receiver 1106, a second bike receiver 1108, and at least one vertical orientation bike receiver 1110. Bike rack 1100 differs from bike rack 100 because instead of a first and second pair of telescoping arms 300 and 400, there is a single first telescopic arm 1102 and a single second telescopic arm 1112. The proximal end of the single second telescopic arm 1112 is mounted to the distal end of the single first telescopic arm 1102. The single second telescopic arm 1112 and the single first telescopic arm 1102 are each hollow and may include mounting holes or other fixtures to which a set of brackets 1114, 1116 may be attached to secure the proximal end of the single second telescopic arm 1112 to the distal end of the single first telescopic arm 1102. Although not shown in detail, the single first telescopic arm 1102 and the single second telescopic arm 1112 each include multiple portions that are sized and shaped to nest within each other and allow for extension and retraction when an actuation assembly is operated, and corresponding force is applied.

Although bike rack 1100 is shown with single first telescopic arm 1102 and a single second telescopic arm 1112, in one or more embodiments, bike rack 1100 includes a single first monolithic arm that is non-telescoping and a single second monolithic arm that is non-telescoping.

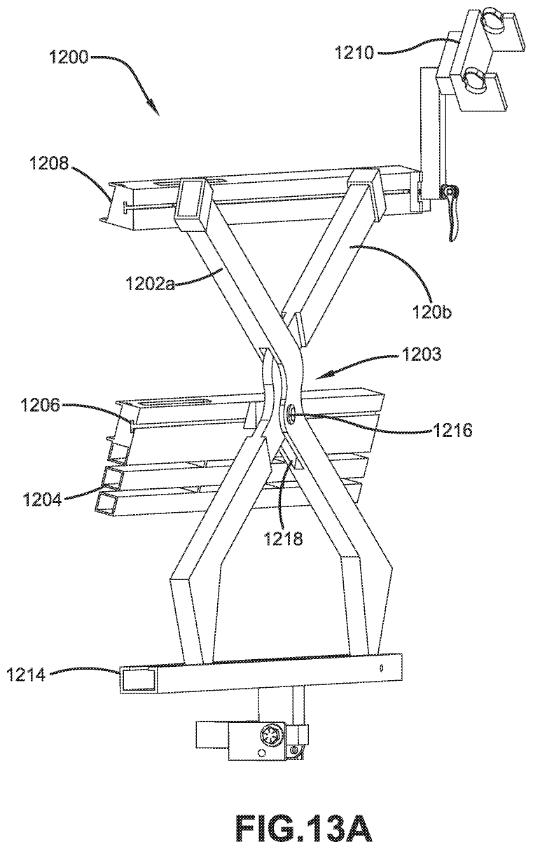

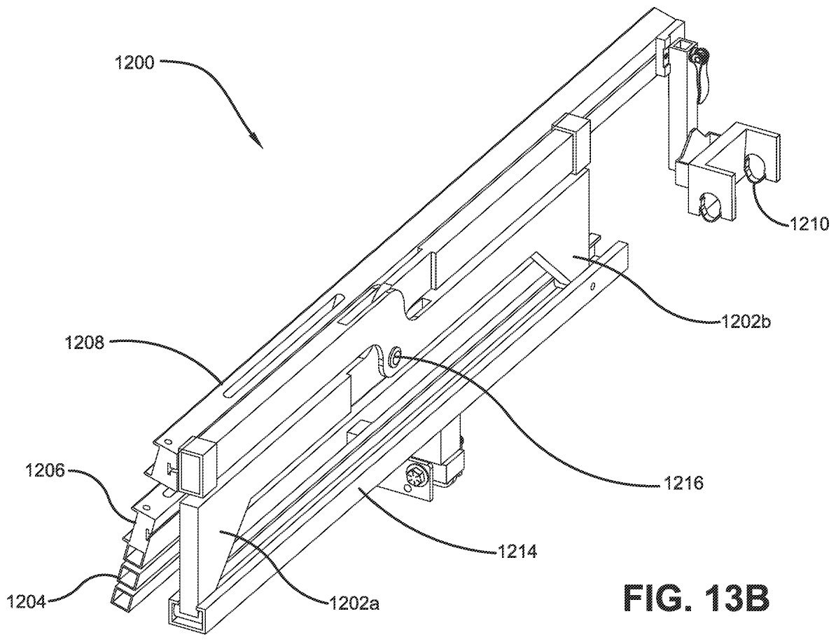

FIG. 13A is a bottom perspective view of a bike rack 1200 in a fully extended state and FIG. 13B is a bottom perspective view of the bike rack 1200 in a storage state. The bike rack 1200 includes a pair of telescopic arms 1202a and 1202b that form an X brace 1203. Similar to bike rack 100, 1000, and 1100, bike rack 1200 includes a cargo assembly 1204, a first bike receiver 1206, a second bike receiver 1208, and at least one vertical orientation bike receiver 1210. Bike rack 1200 differs from bike racks 100, 1000, and 1200 because the pair of telescopic arms 1202a and 1202b cross one another when in an extended state to form X brace 1203 and lay flat on top of one another when in a storage state, as shown in FIG. 13B. The pair of telescopic arms 1202a and 1202b are secured at one end to a pivot bar 1214 and also include one fixed pin 1216 in the middle to allow for the scissor action of extension and retraction. The pair of telescopic arms 1202a and 1202b are also movable within the pivot bar 1214 to assist in the actions of extension and retraction. One of the pair of telescopic arms 1202a or 1202b will include an aperture 1218 in a middle portion thereof to allow for movement of the other of the pair of telescopic arms 1202b or 1202a therein, with assistance from the fixed pin 1216, during the actions of extension and retraction.

Although bike rack 1200 is shown with a pair of telescoping arms 1202a and 1202b that form an X brace 1203, in one or more embodiments bike rack 1200 includes a pair of non-telescoping monolithic arms that form an X brace.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the disclosure to be defined by the claims appended hereto.

What is claimed is:

1. An adjustable bicycle rack for mounting on a vehicle, the rack comprising:
a. a hitch assembly comprising a hitch coupling;
b. a pair of extension arms, wherein a first end of each extension arm of the pair of extension arms is hingedly secured to the hitch assembly; and
c. a first bicycle receiver coupled with the pair of extension arms;
wherein the pair of extension arms are adjustable from a first retracted position to a second extended position.

2. The adjustable bicycle rack of claim 1, wherein a fixed pin located at a center portion of each extension arm of the pair of extension arms allows for the pair of extension arms to adjust from the first retracted position to the second extended position.

3. The adjustable bicycle rack of claim 2, wherein each extension arm of the pair of extension arms includes at least two arm portions, wherein the fixed pin hingedly connects each arm portion of each extension arm of the pair of extension arms together.

4. The adjustable bicycle rack of claim 1, further comprising a second bicycle receiver coupled with the pair of extension arms, wherein the first bicycle receiver is laterally spaced apart from the second bicycle receiver.

5. The adjustable bicycle rack of claim 1, further comprising a cargo assembly coupled with the pair of extension arms.

6. An adjustable bicycle rack for mounting on a vehicle, the rack comprising:
a. a hitch assembly comprising a hitch coupling;
b. a first extension arm, wherein a first end of the first extension arm is hingedly secured to the hitch assembly;
c. a second extension arm, wherein a first end of the second extension arm is hingedly secured to the hitch assembly;
d. a first bicycle receiver coupled with the first extension arm and the second extension arm; and
e. a second bicycle receiver coupled with the first extension arm and the second extension arm; and
wherein the first extension arm is adjustable from a first retracted position to a second extended position, and wherein the second extension arm is adjustable from a first retracted position to a second extended position.

7. The adjustable bicycle rack of claim 6, wherein a fixed pin located at a center portion of first extension arm and the second extension arm allows for the first extension arm and the second extension arm to adjust from the first retracted position to the second extended position.

8. The adjustable bicycle rack of claim 7, wherein both the first extension arm and the second extension arm each include at least two arm portions, and wherein the fixed pin hingedly connects each arm portion of both the first extension arm and the second extension arm together.

9. The adjustable bicycle rack of claim 6, wherein the first bicycle receiver is laterally spaced apart from the second bicycle receiver.

10. The adjustable bicycle rack of claim 6, further comprising a cargo assembly coupled with the pair of extension arms.

11. An adjustable bicycle rack for mounting on a vehicle, the rack comprising:
a. a hitch assembly comprising a hitch coupling;
b. a pair of extension arms, wherein a first end of each extension arm of the pair of extension arms is hingedly secured to the hitch assembly;
c. a hinge located at a center portion of each extension arm of the pair of extension arms; and
d. at least one bicycle receiver, wherein each bicycle receiver of the at least one bicycle receiver is configured to retain a bicycle in a generally vertical orientation;
wherein the pair of extension arms are adjustable at the hinge from a first retracted position to a second extended position for storage of at least one bicycle within the at least one bicycle receiver.

12. The adjustable bicycle rack of claim 11, wherein the hinge includes a fixed pin which allows for the pair of extension arms to adjust from the first retracted position to the second extended position.

13. The adjustable bicycle rack of claim 12, wherein each extension arm of the pair of extension arms includes at least two arm portions, wherein the fixed pin hingedly connects each arm portion of each extension arm of the pair of extension arms together.

14. The adjustable bicycle rack of claim 11, wherein the at least one bicycle receiver is coupled with the pair of extension arms.

15. The adjustable bicycle rack of claim 11, further comprising a cargo assembly coupled with the pair of extension arms.

16. The adjustable bicycle rack of claim 11, wherein the at least one bicycle receiver includes a first bicycle receiver coupled with the pair of extension arms and a second bicycle receiver coupled with the pair of extension arms, wherein the first bicycle receiver is laterally spaced apart from the second bicycle receiver.
